(19) United States
(12) Patent Application Publication
(10) Pub. No.: US 2017/0217384 A1
(43) Pub. Date: Aug. 3, 2017

(54) PROTECTIVE DEVICE FOR A MOTOR VEHICLE

(71) Applicant: Trade Associates, Inc., Kent, WA (US)

(72) Inventor: CLIFFORD TURNBULL, Kent, WA (US)

(73) Assignee: Trade Associates, Inc., Kent, WA (US)

(21) Appl. No.: 15/418,567

(22) Filed: Jan. 27, 2017

Related U.S. Application Data
(60) Provisional application No. 62/288,111, filed on Jan. 28, 2016.

(51) Int. Cl. B60R 13/04

(52) U.S. Cl. CPC B60R 13/04

(57) ABSTRACT

An apparatus for protecting an exterior side of a vehicle according to an example herein includes an elongate body having a contact side for placement opposite a door of a vehicle, a plurality of magnets joined to the body proximate the contact side and configured to retain the elongate body in position against the door, a strap extending from a longitudinal end of the body, and an end weight attached to a free end of the strap, the end weight configured to remain fully inside the vehicle while the door remains closed.

### CROSS-REFERENCE TO RELATED APPLICATION

This application claims the filing benefit of U.S. Provisional Application No. 62/288,111, filed Jan. 28, 2016. This application is incorporated by reference herein in its entirety and for all purposes.

### FIELD OF INVENTION

This invention relates to vehicle protectors, and more particularly to a removable protective device for attachment to a side of a motor vehicle such as a car.

### BACKGROUND OF THE INVENTION

Motor vehicles typically include an outer body, which is made of sheet metal formed to a desired shape for providing desired aerodynamic and aesthetic characteristics of the vehicle. The vehicle's body is typically painted for environmental reasons (e.g., to prevent corrosion) and aesthetic reasons (e.g., to give the vehicle its distinct appearance and aid marketability). With an increasing number of consumers owning a personal vehicle, an increasing number of vehicles now crowd the roads and parking facilities for such vehicles. Motor vehicles typically do not include any protective devices to prevent damage to the exterior aesthetic outer body. The present disclosure describes a protective device for a vehicle exterior which may provide improvements and advantages over existing protective devices.

### SUMMARY OF THE INVENTION

An apparatus for protecting an exterior side of a vehicle may include an elongate body including a contact side for placement opposite a door of a vehicle, a plurality of magnets joined to the body proximate the contact side and configured to retain the elongate body in position against the door, a strap extending from a longitudinal end of the body, and an end weight attached to a free end of the strap, the end weight configured to remain fully inside the vehicle while the door remains closed. In some examples, the strap may be made from a non-elastic material, such as rope. In some examples, the strap may be a multi-strand rope and may have a diameter of about ¼ inch to about 1 and ½ inches. In some examples the diameter of the rope may be at least ½ inch. In some examples, the diameter of the rope may be up to about 2 inches. In some examples, the apparatus may include straps extending from opposite longitudinal ends of the body, a respective end weight attached to free ends of each of the straps. In some examples, the end weight may be hall-shaped. In some examples, the end weight may be made from rubber. In some examples, the strap (e.g., rope) may pass through a bore in the body that extends between the opposite longitudinal ends of the body. In some examples, the body may be movably attached to the strap, for example the strap (e.g., rope) may be movable within the bore. In some examples, the plurality of magnets may include at least three magnets arranged longitudinally along the contact side of the body. In some examples, each of the plurality of magnets may be received within a recess in a contact side of the body and a protective cover may be provided over an exposed surface of each of the plurality of magnets. In some examples, the protective cover may be felt tape, duct tape, or the like. In some examples, the rope may be received in a bore formed in the body and retained therein with a washer. In some examples, the body may be made from closed-cell foam. In some examples, the contact side may include a ridged surface. In some examples, the contact side may include a plurality of grooves.

According to an example, a method of protecting an exterior side of a vehicle may include the steps of positioning an elongate body of a door protector including a contact side opposite a door of a vehicle, retaining the elongate body in position against the door of the vehicle with a plurality of magnets provided along the contact side, placing a strap extending from a longitudinal end of the body at least partially inside the vehicle such that an end weight attached to a free end of the strap is positioned fully inside the vehicle, and closing the door of the vehicle to pinch the strap between an edge of the door and a doorframe of the vehicle. In some examples, the strap may be a first strap extending from a first longitudinal end of the body and the door protector may include a second strap extending from a second longitudinal end of the body opposite the first longitudinal end. The method may further include the step of placing the second strap at least partially inside the vehicle such that an end weight attached to a free end of the second strap is positioned fully inside the vehicle.

### BRIEF DESCRIPTION OF THE DRAWINGS

Specific forms, configurations, embodiments and/or diagrams relating to and helping to describe preferred versions of the invention are explained and characterized herein, often with reference to the accompanying drawings. The drawings and all features shown therein also serve as part of the disclosure of the invention whether described in text or merely by graphical disclosure alone. Such drawings are briefly described below.

FIG. 1 is an illustration of a door protector attached to a vehicle door in accordance with the present disclosure.

FIG. 2 is an isometric view of a door protector according to some examples herein.

FIG. 3 is a plan view of the door protector in FIG. 2.

FIG. 4 is a partial isometric view of the door protector in FIG. 2.

FIG. 5A is a cross-sectional view of the door protector in FIG. 2 taken at line 5A-5A in FIG. 3.

FIGS. 5B and 5C are cross-sectional views of door protectors according to further examples present disclosure.

FIG. 6 is a flow diagram of a process according to some examples of the present disclosure.

### DETAILED DESCRIPTION OF PREFERRED EMBODIMENTS

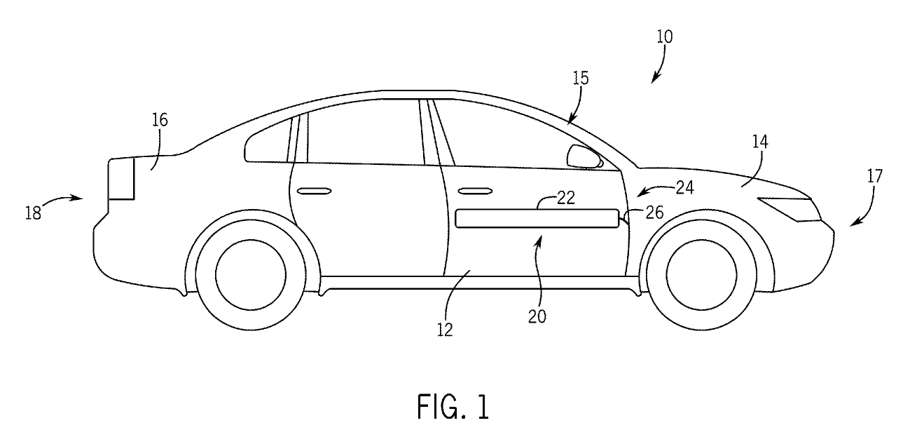

Referring now to the figures, apparatuses and methods for protecting an exterior side of a vehicle according to some embodiments are described in further detail. FIG. 1 illustrates a protective device for protecting an exterior side of a vehicle. The protective device 20 in FIG. 1 is illustrated attached to a vehicle door 12 in accordance with some examples of the present disclosure, and may be interchangeably referred to as door protector. Although the protective device 20 is shown attached to a vehicle door, it will be understood that the protective device 20 may be similarly used to protect other parts of the vehicle's exterior, for example a forward body panel 14, an aft body panel 16, a forward or read ends 17, 18 of the vehicle, or others. The protective device 20 is configured to be magnetically attached to the exterior body of the vehicle 10, for example the door 12. The door protector in FIG. 1 is implemented in the form of a generally elongate member 22 having a generally rectangular shape. Other form factors (oval or irregularly shaped members) may be used in other examples as may be appropriate for protecting a particular portion of the vehicle exterior. The protective device 20 is made from a lightweight material, such that magnetic force may sufficiently be used to retain the protective device 20 in position against the vehicle door. The protective device 20 includes a security device 24 which may reduce the risk of theft of the protective device 20. For example, the security device 24 may be implemented in the form of a strap 26 or a plurality of straps 26. The strap 26 may extend from one end or both ends of the protective device 20. The strap 26 may be configured such that at least a portion of the strap 26 is positioned inside the vehicle when the door 12 is closed. The strap 26 may be configured such as to prevent removal of the enclosed portion of the strap 26 from inside the vehicle while the door 12 remains closed.

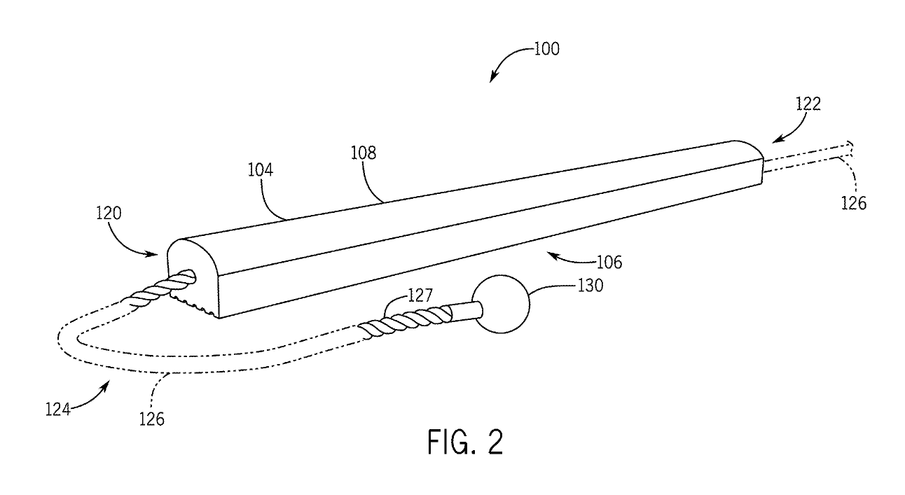

FIGS. 2-7 illustrate views of a protective device according to one embodiment. The protective device may be used as a door protector and may thus interchangeably be referred to hereinafter as door protector. The door protector 100 includes an elongate body 104 which has a contact side 106 and an outer side 108 (which may also be referred to as impact side). In the illustrated example, the contact side 106 is generally planar; however in other examples, the contact side may be curved, slightly or substantially, to match a contour of the vehicle door. In some examples, the contact side 106 may be contoured along the longitudinal direction, the transverse direction, or both such as to match either or both longitudinal and/or transvers contours of the vehicle door.

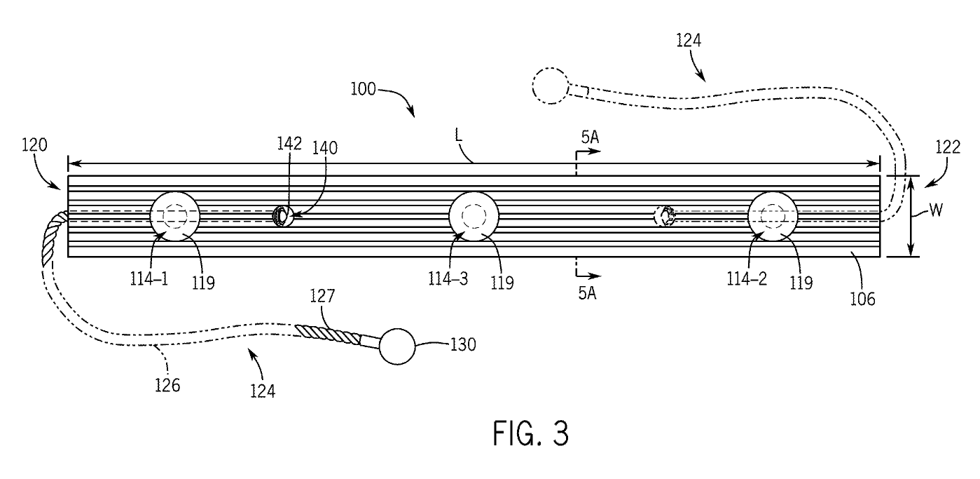

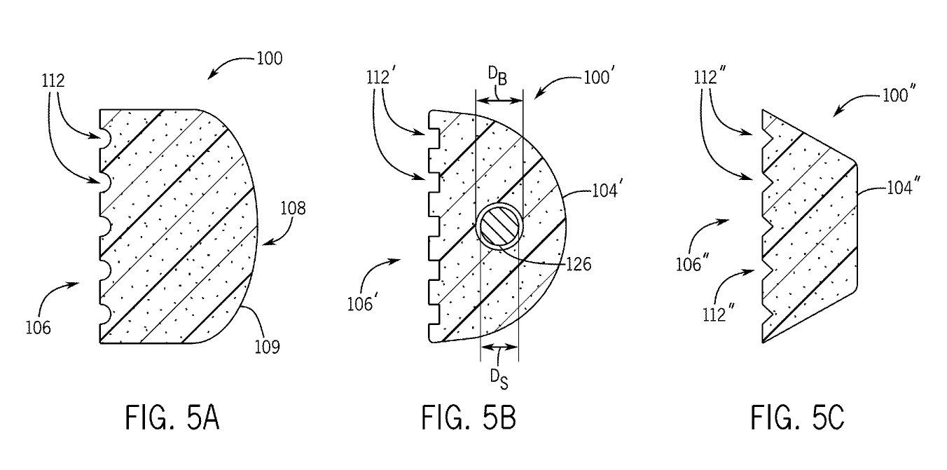

The elongate body 104 is made from a light-weight material, for example closed-cell foam. Other light-weight materials may be used. The elongate body 104 has a generally rectangular shape in plan view (see FIG. 3), with a length L and a width W. The length and width may be selected to fit any make or model vehicle. For example, the length L may be selected such that the elongate body 104 does not extend beyond the length of the vehicle door. While a continuous body is illustrated in the example in FIGS. 2-7, it will be understood that the elongate body 104 may be formed of a plurality of shorter bodies connected in series to form the elongate body 104. In the illustrated example in FIGS. 2-5A, the elongate body 104 has a nearly rectangular cross-section (see FIG. 5A) with a rounded or domed profile 109 at the outer side, which may enhance the performance of the door protector by providing additional impact absorbing material at the outer side (e.g., the impact side). The elongate body 104 may have the same or varying cross-section along its length L. In some examples, the elongate body 104 may have a ridged contact surface. In some examples, the elongate body 104 may include grooves 112 on the contact side 106 of the body 104. The grooves 112 may provide certain aesthetic and/or functional advantages. In some examples, the grooves 112 may be configured to increase the traction between the elongate body 104 and the vehicle door 12 and/or to help to distribute the load from the impact and thereby minimize damage to the door 12. In some examples, the grooves 112 may be purely aesthetic. Other cross sections for the elongate body and/or grooves may be used in other examples. For example, a protective device 100′ may have an elongate body 104′ with a generally semicircular or semi-ovular cross section as illustrated in FIG. 5B. A contact side 106′ of the protective device 100 may include generally rectangular grooves 112′. In further examples, a protective device 100″ may have an elongate body 104″ with a generally trapezoidal cross section as illustrated in FIG. 5C. A contact side 160″ of the protective device 100″ may include generally triangular grooves 112″. In other examples, the grooves 112 may be discontinuous and/or the grooves 112 may extend only partially along the length of the body 104. Any of the cross-sections and groove shapes and/or patterns illustrated and appreciated in view of this disclosure may be used in any combination in some embodiments.

During use, the contact side 106 is placed opposite the door 12 of the vehicle and the door protector 100 is retained against the vehicle door 12 by way of one or more magnets 114. The magnets 114 are provided on or proximate the contact side 106. In the illustrated example, the magnets 114 are received in recesses 118 along the contact side 106. In other examples, the one or more magnets 114 may be embedded in the elongate body 104 just below the surface of the contact side 106. The number of magnets 114 and sizes of the magnets may be tailored to minimize overall weight of the door protector 100 while still providing the necessary magnetic attraction to retain the door protector 100 in position against the vehicle door 12. In some examples, the door protector 100 includes at least two magnets 114 which may provide a stable two-point attachment to the vehicle door 12. In other examples, different number of magnets may be used, such as a single magnet, or any number (3, 4, 5, 6, 7, 8, 9, 10 or more) of magnets arranged proximate the contact side 106.

In the illustrated example, the door protector 100 includes three magnets spaced along the length L of the elongate body 104 (see FIG. 3). A first magnet 114-1 is positioned near one of the longitudinal ends 120 and a second magnet 114-2 is positioned near the opposite longitudinal end 122 of the elongate body 104. A third magnet 114-3 is positioned at an intermediate location between the first and second magnets 114-1, 114-2. The magnets 114-1, 114-2, and 114-3 may be generally equally spaced along the length L. For example, the third magnet 114-3 may be spaced an equal distance from the first and second magnets 114-1 and 114-2. The magnets 114-1, 114-2, and 114-3 in this example are generally aligned; however the magnets may be staggered (transversely offset from one another) in other examples. Any number of arrangements may be used, for example transversely staggering the magnets and/or varying the distance between the magnets as may be suitable to optimize the holding strength of the door protector while reducing overall weight.

In the illustrated example, the magnets 114 are received within recesses 118 defined by the surface of contact side 106. A protective cover 119 is provided on the exposed surfaces of the magnets 114, such as to protect the aesthetic exterior of the vehicle 10 (e.g., from scratch) when the door protector 100 is attached thereto. In some examples, the protective cover 119 may he implemented using felt tape, duct tape, or other suitable plastic, fabric, or synthetic material. In some examples, polyethylene (PE) cloth duct tape may be used. The protective cover 119 (e.g., PE cloth duct tape) may include an adhesive layer for securely attaching the cover 119 to the exposed surface of the magnets 114.

As described, the door protector includes a security device 124 which may reduce the risk of theft. The security device 124 may be implemented in the form of a strap 126. In some examples, the strap 126 is made from a non-elastic material such as a rope 127. A thickness of the strap 126 (e.g., diameter Ds, in FIG. 5B) may be selected such that at least a portion of the strap 126 remains inside the vehicle while the door 12 remains closed. In some examples, a rope 127, such as a multi-strand rope having a diameter of at least ½ inch, may be used so as to enable the rope 127 to become pinched between the door 12 and door frame 15 of the vehicle 10 thereby reducing the risk that a potential thief can separate the protective device 100 from the vehicle. The use of a multi-strand rope (e.g., a rope with helically wound strands) may be additionally advantageous by providing an irregular (e.g., helically ribbed) surface which may increase the friction between the rope and the door and door frame. The strap 126 (e.g., rope 127) need not be tensioned to function properly. That is, during use the strap 126 may be slack between its attachment point to the body 104 and its pinched location between the door 12 and door frame 15. The strap 126 may nevertheless prevent a potential thief from freeing the door protector 100 from engagement, e.g., by virtue of the thickness (e.g., diameter Ds) of the strap 126, which may not be easily removable from between the door 12 and door frame 15 with the door closed.

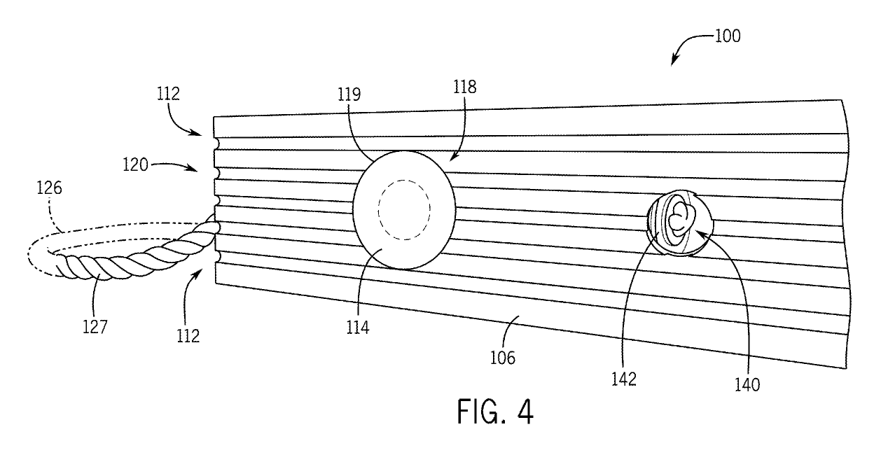

In some examples, the protective device 100 may include a single strap 126 attached to one end of the body 104, or optionally it may include two straps at each end of the body 104. The strap 126 may be securely attached to the body 104, for example by molding the strap 126 to the body 104. In some examples, the body 104 may be formed by expanding foam into a form (i.e., mold) and the foam may be overmolded to the strap 126 thereby embedding an end of the strap 126 in the body 104. In the illustrated example, the strap 126 is received in a bore 140 formed in the body 104 and secured thereto using a washer 142 (see FIG. 4). In some examples, the strap 126 may be immovably attached to the body 104 (e.g., by adhering the strap thereto). In some examples, the strap 126 may be movably attached to the body 104. In some examples, the strap 126 may pass through the body 104 (see e.g., FIG. 5B) and extend from the opposite end 120, 122 of the body 104. The body 104 may include a longitudinal bore (e.g., bore 140), which may extending from one longitudinal end 120 of the body 104 to the opposite longitudinal end 122 of the body 104. The strap 126 (e.g., rope 127) may pass through the bore 140 and project form the opposite ends 120, 122. In such examples, it may be said that the protective device includes two straps extending form the opposite ends 120, 122. In yet further examples, two separate straps may be used, each attached to respective one of the opposite ends. In some examples, the body 104 may be slidable relative to the strap 126. That is, a diameter of the bore (Db) may be larger than a diameter of the strap (Ds) thereby allowing for a clearance fit between the two. In some examples, the diameters of the bore and the strap (Db, Ds respectively) may be substantially the same and the strap 126 may nevertheless still be able to slide (with minimal friction) within the bore 140. Regardless of the number of straps, the straps provided at one or both ends 120, 122 may be similar in construction and operation. For example, during use, the user would place a portion of each strap inside the vehicle before closing the door and a portion of each of the straps will then become enclosed inside the vehicle to function as a security device for the door protector. In yet further examples, more than one strap may be provided at each of the ends 120, 122.

In some examples, the security device 124 may include an end weight 130 attached to the free end of the strap 126. In cases, where a plurality of straps are used, a respective number of end weights may be used, each of which may be attached to a free end of a strap. The end weight 130 may be attached to the strap 126 using conventional techniques (e.g., fastened, adhered, molded thereto). The end weight 130 may be ball-shaped, in some examples. In other examples, the end weight 130 may be shaped as a block having a different shape, such as a cone, a prism, a rectangular or square parallelepiped, or an irregular shape. During use, the user places the end weight 130 inside the vehicle 10. When the door 12 is closed, the end weight 130 and a portion of the strap 126 will remain inside the vehicle 10 while the door 12 remains closed. The end weight 130 may be configured to remain fully inside the vehicle while the door 12 remains closed. For example, the shape and/or size of the end weight 130 may be selected such that the end weight 130 cannot pass through a gap between the door 12 and door frame 15 when the door 12 is closed. A dimension of the end weight 130 (e.g., a diameter of a ball-shaped end weight) may be greater than a dimension of the strap 126 (e.g., a diameter of the rope). In some examples, the dimension of the end weight 130 (e.g., a diameter of a ball-shaped end weight) may be two times, three times, four times greater or more than a dimension of the strap 126 (e.g., a diameter of the rope). In some examples, the end weight 130 may be made from rubber. Other materials which provide sufficient stiffness to prevent significant deformation of the end weight may be used.

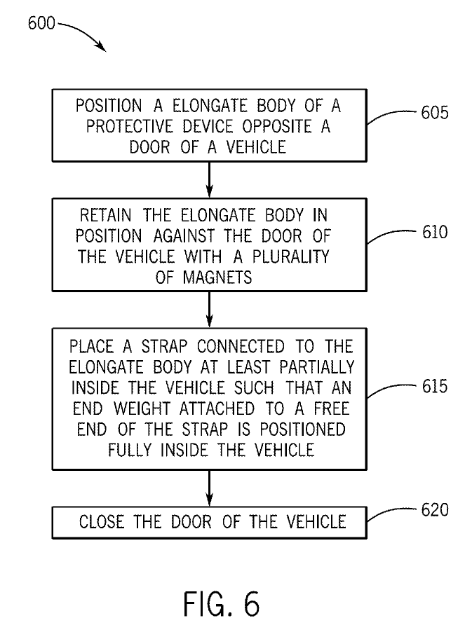

FIG. 6 is a flow diagram of a process according to some examples herein. An example method 600 may include positioning an elongate body (e.g., body 104) of a protective device including a contact side (e.g., door protector 100) opposite a door of a vehicle (e.g., door 12 of vehicle 10), as shown in block 605. The method 600 may include retaining the elongate body in position against the door of the vehicle with a plurality of magnets (e.g., magnets 114) provided along the contact side, as shown in block 610. The method 600 may further include placing a strap (e.g., rope 127 of door protector 100) extending from a longitudinal end of the body at least partially inside the vehicle such that an end weight attached to a free end of the strap (e.g., end weight 130 of door protector 100) is positioned fully inside the vehicle, as shown in block 615. The method 600 may further include closing the door of the vehicle to cause the strap to become pinched between an edge of the door and a doorframe of the vehicle, as shown in block 620. In this manner, the door protector may remain generally in position against the door by virtue of the magnets. In the even that a potential thief attempts to remove the door protector from the vehicle, e.g., by disengaging the magnets from the door, the door protector may nonetheless remain attached to the vehicle by virtue of the security device (e g., strap 126 and/or end weight 130). The strap extending from the door protector and to the inside of the vehicle may prevent potential theft. The strap may be retained inside the vehicle by virtue of a thickness of the strap and/or a size/shape of an end weight which may be provided at an end of the strap. The method may not require tension of the strap against the vehicle body (e.g., door or door frame) but the strap may instead remain slack during use. In some examples, such as when a plurality of straps are provided, the method may include placing a portion of each of the straps inside the vehicle such that at least a portion of each strap and/or an end weight attached to each strap is positioned inside the vehicle prior to closing the door.

Example A

A door protector comprising a foam body of approximately 28 in in length, approximately 3 in in width and approximately 2¾ in thick was successfully tested. A plurality of longitudinally extending parallel grooves, having a depth of about an ⅛ of an inch or less, were formed on the contact side of the body. Three magnets having annular shape, e.g., to minimize additional weight, with an approximate 1¾ in diameter and an approximate ¼ inch thickness, were adhered to recesses having corresponding depth and diameter in the contact side of the body. PE cloth duct tape was adhered to the exposed side of the magnets so as to substantially cover the whole exposed side of the magnets. Each of the outer magnets was positioned about 4 in from ends of the body and a middle magnet was positioned about the same distance between the outer magnets. A multi-strand rope having a diameter of about ½ in was inserted in a ⅝ in bore extending about 7½ in into the length of the body. The rope was secured with a knot and washer inside the bore. During testing, the door protector remained attached to the door by virtue of magnetic attraction between the magnets and car door, while the rope, a portion of which was placed inside the vehicle, e.g., between the forward end of the door and door frame, remained secured therebetween upon the application of normal pulling force (e.g. about 20 lbs).

The above detailed description of examples is not intended to be exhaustive or to limit the method and systems to the precise form disclosed above. While specific embodiments of, and examples for, the method and apparatuses for protecting an exterior of a vehicle are described above for illustrative purposes, various equivalent modifications are possible within the scope of the present disclosure, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. It will be further appreciated that one or more components of the protective devices illustrated in a specific figure described herein may be used in other combination with any of the components of base units, electronic devices, or systems of any of the examples described herein.

What is claimed is:

1. An apparatus for protecting an exterior side of a vehicle, comprising:
an elongate body including a contact side for placement opposite a door of a vehicle;
a plurality of magnets joined to the body proximate the contact side and configured to retain the elongate body in position against the door;
a strap extending from a longitudinal end of the body; and
an end weight attached to a free end of the strap, the end weight configured to remain fully inside the vehicle while the door remains closed.

2. The apparatus of claim 1, wherein the strap comprises a non-elastic material.

3. The apparatus of claim 1, wherein the strap comprises a rope.

4. The apparatus of claim 1, wherein the strap comprises a multi-strand rope having a diameter of at least ½ inch.

5. The apparatus of claim 1, wherein the strap includes a first strap extending from a first longitudinal end of the body and a second strap extending from a second longitudinal end of the body opposite the first longitudinal end, a respective end weight attached to free ends of each of the first and second straps.

6. The apparatus of claim 1, wherein the end weight is ball-shaped.

7. The apparatus of claim 1, wherein the end weight is made from rubber.

8. The apparatus of claim 1, wherein the plurality of magnets includes at least three magnets are arranged longitudinally along the contact side of the body.

9. The apparatus of claim 1, wherein each of the plurality of magnets is received within a recess in a contact side of the body, the apparatus further comprising a protective cover over an exposed surface of each of the plurality of magnets.

10. The apparatus of claim 1, wherein the protective cover comprises a felt tape.

11. The apparatus of claim 1, wherein the protective cover comprises duct tape.

12. The apparatus of claim 1, wherein the body is made from closed-cell foam.

13. The apparatus of claim 1, wherein the contact side has a ridged surface.

14. The apparatus of claim 1, wherein the rope passes through a bore in the body between the opposite longitudinal ends of the body.

15. The apparatus of claim 1, wherein the body is movably attached to the rope.

16. The apparatus of claim 1, wherein the rope is received in a bore formed in the body and retained therein with a washer.

17. A method of protecting an exterior side of a vehicle, comprising:
positioning an elongate body of a door protector including a contact side opposite a door of a vehicle;
retaining the elongate body in position against the door of the vehicle with a plurality of magnets provided along the contact side;
placing a strap extending from a longitudinal end of the body at least partially inside the vehicle such that an end weight attached to a free end of the strap is positioned fully inside the vehicle; and
closing the door of the vehicle to pinch the strap between an edge of the door and a doorframe of the vehicle.

18. The method of claim 17, wherein the strap is a first strap extending from a first longitudinal end of the body, the door protector further comprising a second strap extending from a second longitudinal end of the body opposite the first longitudinal end, the method further comprising placing the second strap at least partially inside the vehicle such that an end weight attached to a free end of the second strap is positioned fully inside the vehicle.
